(19) United States
(12) Patent Application Publication
(10) Pub. No.: US 2022/0236732 A1
(43) Pub. Date: Jul. 28, 2022

(54) REMOTE MOVING SYSTEM

(71) Applicant: TOYOTA JIDOSHA KABUSHIKI KAISHA, Toyota-shi (JP)

(72) Inventors: Toshihiro YASUDA, Toyota-shi (JP); Shinya SANNODO, Toyota-shi (JP)

(73) Assignee: TOYOTA JIDOSHA KABUSHIKI KAISHA, Toyota-shi (JP)

(21) Appl. No.: 17/499,020

(22) Filed: Oct. 12, 2021

(30) Foreign Application Priority Data
Jan. 26, 2021 (JP) 2021-010175

(51) Int. Cl. G05D 1/00; B60W 30/06; B60W 10/04; B60W 10/18; B60W 10/20; G06F 3/0488

(52) U.S. Cl. CPC G05D 1/0016; B60W 30/06; B60W 10/04; B60W 10/18; G05D 1/0038; G06F 3/0488; B60W 2710/18; B60W 2710/20; B60W 10/20

(57) ABSTRACT

A remote moving system for remotely moving a vehicle with an operation terminal outside of the vehicle. The operation terminal wirelessly communicates with the vehicle electronic control unit. The vehicle electronic control unit executes a remote moving control of receiving a signal from the operation terminal and moving the vehicle along a predetermined route in accordance with the received signal. The operation terminal changes its state from a first state to a second state when the operation terminal is in the first state, and a first interaction is applied to the operation terminal, and transmits a signal of commanding to move the vehicle to the vehicle electronic control unit when the operation terminal is in the second state, and a second interaction different from the first interaction is applied to the operation terminal.

### BACKGROUND

### Field

The invention relates to a remote moving system.

### Description of the Related Art

There is known a remote moving system which allows a user of a vehicle to utilize a remote moving function of remotely moving and parking the vehicle in a parking space by using a portable terminal such as a portable phone (for example, see JP 2016-74285 A). The user can move the vehicle by applying touch interactions to a display of the portable terminal with the remote moving function of the known remote moving system.

The remote moving function of the known remote moving system moves the vehicle in response to the touch interactions to the display of the portable terminal. Thus, if the user mistakenly touches the display or clothes of the user contacts the display, the vehicle is moved without user's intention.

### SUMMARY

An object of the invention is to provide a remote moving system which can prevent the remote moving function from moving the vehicle without user's intention.

A remote moving system according to the invention remotely moves a vehicle with an operation terminal outside of the vehicle. The vehicle includes a vehicle moving apparatus which drives, brakes, and steers the vehicle and a vehicle electronic control unit which controls activations of the vehicle moving apparatus. The operation terminal is configured to wirelessly communicate with the vehicle electronic control unit. The vehicle electronic control unit is configured to execute a remote moving control of (i) receiving a signal which is wirelessly transmitted from the operation terminal and (ii) moving the vehicle along a predetermined route by controlling the activations of the vehicle moving apparatus in accordance with the received signal. The operation terminal is configured to change its state from a first state to a second state when (i) the operation terminal is in the first state, and (ii) a predetermined first interaction is applied to the operation terminal. Further, the operation terminal is configured to transmit a signal of commanding to move the vehicle to the vehicle electronic control unit when (i) the operation terminal is in the second state, and (ii) a predetermined second interaction different from the predetermined first interaction is applied to the operation terminal.

If the operation terminal is in a pocket of a shirt or a bag of the user, a cloth of the shirt or a leather of the bag may constantly contact the operation terminal. Thus, the predetermined first interaction and the predetermined second interaction may be applied to the operation terminal by the cloth or the leather. In this case, the state of the operation terminal changes from the first state to the second state. Then, the signal of commanding to move the vehicle is transmitted. In this case, the vehicle is unintentionally moved.

With the remote moving system according to the invention, the predetermined first interaction of changing the state of the operation terminal from the first state to the second state and the predetermined second interaction of transmitting the signal of commanding to move the vehicle, are different from each other. Thus, even when the cloth of the shirt or the leather of the bag constantly contacts the operation termina, the signal of commanding to move the vehicle is unlikely to be transmitted. Thus, the remote moving control can be prevented from moving the vehicle without user's intention.

According to an aspect of the invention, the remote moving control may be one of (i) a remote parking control of parking the vehicle in a parking space and (ii) a remote pulling-out control of pulling out the vehicle from the parking space.

With the remote moving system according to this aspect of the invention, the remote parking control or the remote pulling-out control can be prevented from moving the vehicle without user's intention.

According to another aspect of the invention, the operation terminal may include a display. Further, the predetermined first interaction and the predetermined second interaction may be touch interaction to the display, respectively. Furthermore, the touch interaction as the predetermined first interaction may be one of (i) a swiping interaction, (ii) a sliding interaction, (iii) a long-pressing interaction, (iv) a tapping interaction, (v) an interaction of drawing a predetermined line, (vi) an interaction of inputting numbers, and (vii) a continuous touch interaction. Furthermore, the touch interaction as the predetermined second interaction may be different from the touch interaction as the predetermined first interaction and be one of (i) the swiping interaction, (ii) the sliding interaction, (iii) the long-pressing interaction, (iv) the tapping interaction, (v) the interaction of drawing the predetermined line, (vi) the interaction of inputting the numbers, and (vii) the continuous touch interaction.

If (i) the operation terminal is configured to transmit the signal of commanding to move the vehicle in response to the touch interaction being applied to the display, and (ii) the cloth of the shirt or the leather of the bag contacts the display of the operation terminal in the pocket of the shirt or the bag, the contact of the cloth or the leather to the display is likely to be recognized as the touch interaction applied to the display. Thus, the signal of commanding to move the vehicle is likely to be transmitted. With the remote moving system according to this aspect of the invention, the touch interaction as the predetermined first interaction and the touch interaction as the predetermined second interaction are different from each other. Thus, even when the cloth of the shirt or the leather of the bag contacts the display, the signal of commanding to move the vehicle is unlikely to be transmitted. Thus, the remote moving control can be prevented from moving the vehicle without user's intention.

According to further aspect of the invention, the operation terminal may be configured to change its state to the first state when plural kinds of interactions are applied to the operation terminal after the operation terminal starts up an application software of causing the vehicle electronic control unit to execute the remote moving control. Further, the plural kinds of the interactions may be different from each other and are different from the predetermined first interaction.

If (i) the application software of executing the remote moving control has been started up, and (ii) the cloth of the shirt or the leather of the bag contacts the operation terminal, the signal of commanding to move the vehicle is likely to be transmitted. With the remote moving system according to this aspect of the invention, the state of the operation terminal changes to the first state in response to the plural kinds of the interactions being applied to the operation terminal after the application software is started up. In addition, the plural kinds of the interactions are different from each other and are also different from the predetermined first interaction. Thus, even when the cloth or the leather contacts the operation terminal, the state of the operation terminal is unlikely to change to the second state. Thus, the remote moving control can be prevented from moving the vehicle without user's intention.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a view which shows a remote moving system according to an embodiment of the invention.

FIG. 2 is a view which shows the remote moving system according to a modified example of the embodiment of the invention.

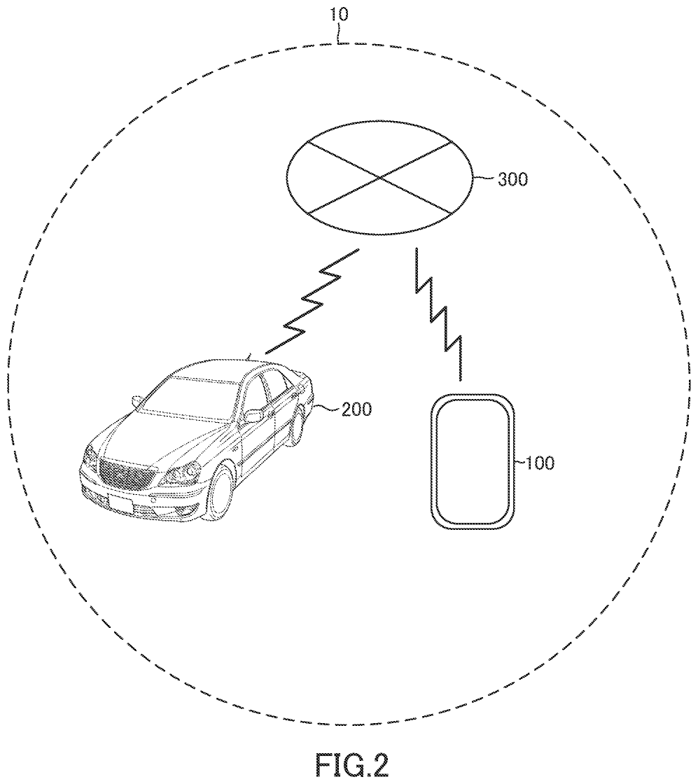

FIG. 3 is a view which shows the remote moving system according to another modified example of the embodiment of the invention.

FIG. 4. is a view which shows an operation terminal which belongs to the remote moving system according to the embodiment of the invention and an ECU, etc. of the operation terminal.

FIG. 5 is a view which shows a vehicle which belongs to the remote moving system according to the embodiment of the invention and an ECU, etc. of the vehicle.

FIG. 6 is a view which shows the operation terminal which displays an initial display image on a display.

FIG. 7 is a view which shows the operation terminal which displays a parking/pulling-out selecting image on the display.

FIG. 8 is a view which shows the operation terminal which displays a parking space selecting image on the display.

FIG. 9 is a view which shows the operation terminal which displays a parking interacting image on the display.

FIG. 10 is a view which displays the operation terminal which displays the parking interacting image on the display.

FIG. 11 is a view which shows the operation terminal which displays the parking interacting image on the display.

FIG. 12 is a view which shows the operation terminal which displays the parking interacting image on the display.

FIG. 13 is a view which shows the operation terminal which displays a pulling-out direction selecting image on the display.

FIG. 14 is a view which displays the operation terminal which displays a pulling-out interacting image on the display.

FIG. 15 is a view which displays the operation terminal which displays the pulling-out interacting image on the display.

FIG. 16 is a view which displays the operation terminal which displays the pulling-out interacting image on the display.

FIG. 17 is a view which shows a flowchart of a routine executed by a terminal ECU according to the embodiment of the invention.

FIG. 18 is a view which shows a flowchart of a routine executed by the terminal ECU according to the embodiment of the invention.

FIG. 19 is a view which shows a flowchart of a routine executed by the terminal ECU according to the embodiment of the invention.

FIG. 20 is a view which shows a flowchart of a routine executed by a vehicle ECU according to the embodiment of the invention.

FIG. 21 is a view which shows a flowchart of a routine executed by the vehicle ECU according to the embodiment of the invention.

FIG. 22 is a view which shows a flowchart of a routine executed by the vehicle ECU according to the embodiment of the invention.

### DESCRIPTION OF THE PREFERRED EMBODIMENTS

Below, a remote moving system according to an embodiment of the invention will be described with reference to the drawings. The remote moving system according to the embodiment of the invention described below is a remote parking/pulling-out system which (i) remotely moves and parks a vehicle in a parking space with an operation terminal outside of the vehicle and (ii) remotely moves and pulls out the vehicle from the parking space with the operation terminal outside of the vehicle.

In this regard, the remote moving system according to the invention is not limited to one described above. The remote moving system according to the invention may be any systems which execute the remote moving control of remotely moving the vehicle with the operation terminal outside of the vehicle.

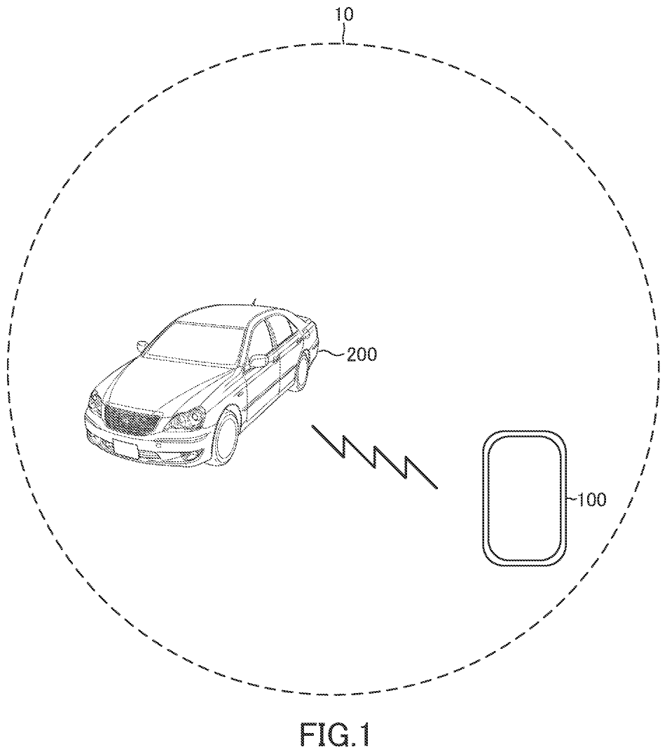

As shown in FIG. 1, the remote moving system 10 according to the embodiment of the invention includes an operation terminal 100 and a vehicle 200.

The operation terminal 100 and the vehicle 200 of the remote moving system 10 can wirelessly transmit and receive various signals to and from each other. In this regard, the remote moving system 10 may be configured to include the operation terminal 100, the vehicle 200 and an internet 300 and allow the operation terminal 100 and the vehicle 200 to transmit and receive various signals to and from each other via the internet 300.

Further, the remote moving system 10 may be configured to include the operation terminal 100, the vehicle 200, the internet 300, and at least one server 301 and allow the operation terminal 100 and the vehicle 200 to transmit and receive various signals to and from each other via the internet 300 and the server 301.

<Operation Terminal>

The operation terminal 100 of this embodiment is a so-called smart phone which is a portable phone. In this regard, the operation terminal 100 may be any terminal which is separated from the vehicle 200 and which a user of the vehicle 200 can bring to the outside of the vehicle 200. For example, the operation terminal 100 may be a portable key such as a so-called smart key or a portable terminal dedicated to a remote parking function.

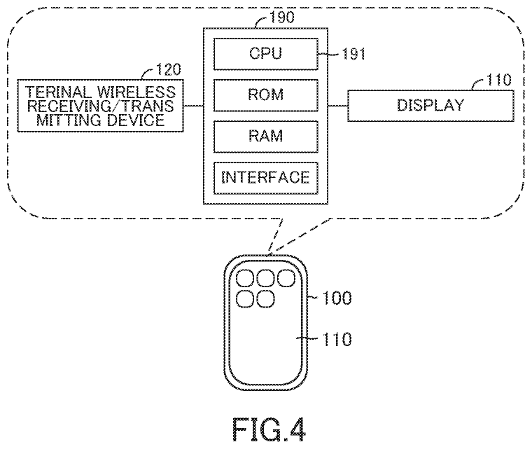

As shown in FIG. 4, the operation terminal 100 includes a display 110, a terminal wireless receiving/transmitting device 120, and a terminal ECU 190.

ECU stands for electronic control unit. The terminal ECU 190 includes a micro-computer as a main component. The terminal ECU 190 includes a CPU, a ROM, a RAM, a non-volatile memory, and an interface. Hereinafter, the CPU of the terminal ECU 190 will be referred to as “terminal CPU 191”. The terminal CPU 191 realizes various functions by executing instructions, or programs, or routines memorized in the ROM. A remote moving application software is installed in the terminal ECU 190. The remote moving application software is a software of causing an ECU of the vehicle 200 to execute a remote parking/pulling-out control described later. Hereinafter, the ECU of the vehicle 200 will be referred to as “vehicle ECU 290”, and the remote moving application software will be referred to as “remote moving application”.

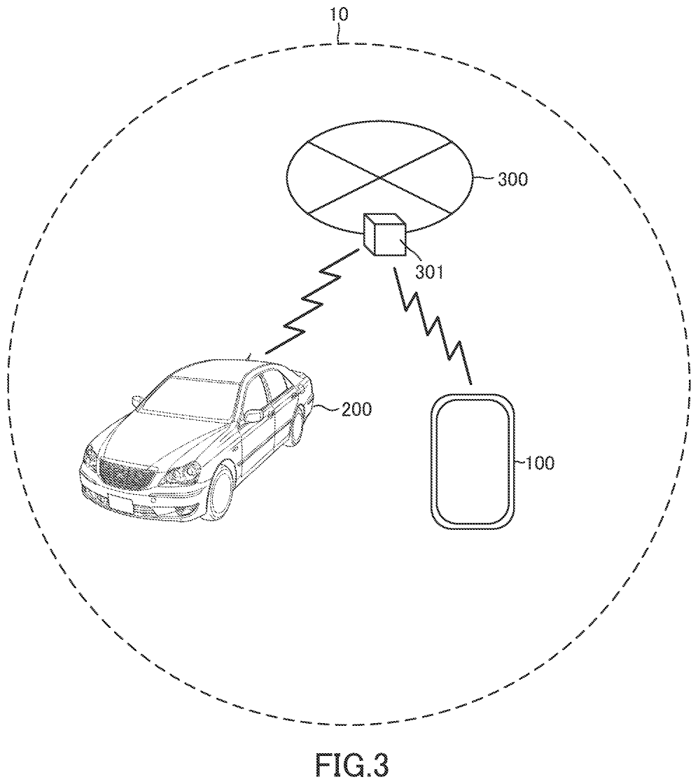

When the remote moving system 10 is configured as shown in FIG. 3, the remote moving system 10 may be configured such that programs stored in the server 301 realizes a part of functions realized by the remote moving application installed in the terminal ECU 190. Further, when the remote moving system 10 is configured as shown in FIG. 3, the remote moving system 10 may be configured such that the remote moving application installed in the terminal ECU 190 is updated by the server 301.

The display 110 is a device which displays various images. Further, the display 110 is a display which has a physical property which changes in response to things touching it. In particular, the physical property of the display 110 of this embodiment changes in response to a finger of a human touching the display 110.

The display 110 is electrically connected to the terminal ECU 190. The terminal ECU 190 can display various images on the display 110. Further, the terminal ECU 190 can detect predetermined changes of the physical property of the display 110 derived from things touching it and determine portions of the display 110 which the things touch, i.e., positions on the display 110, based on the detected changes.

As described above, the terminal ECU 190 can determine the portions of the display 110 which the things touch, based on the predetermined changes of the physical property of the display 110. Thus, the display 110 is a touch information providing device which provides information which can be used to determine the portions of the display 110 which the things touch. In this embodiment, the touch information providing device is the display 110. However, the touch information providing device is not limited to the display 110. The touch information providing device is required at least to provide the information which can be used to determine the portions of the operation terminal 100 which the things touch. For example, the touch information providing device may be a device which does not have any functions of displaying the images, but has functions of providing the information which can be used to determine the portions of the touch information providing device which the things touch.

The terminal wireless receiving/transmitting device 120 is electrically connected to the terminal ECU 190. The terminal ECU 190 can transmit various signals to the outside of the operation terminal 100 via the terminal wireless receiving/transmitting device 120. Further, the terminal ECU 190 can receive various signals which the vehicle ECU 290 of the vehicle 200 to the outside of the vehicle 200 via a vehicle wireless receiving/transmitting device 275, via the terminal wireless receiving/transmitting device 120.

As described above, the operation terminal 100 is configured to wirelessly communicate with the vehicle ECU 290 of the vehicle 200.

<Vehicle>

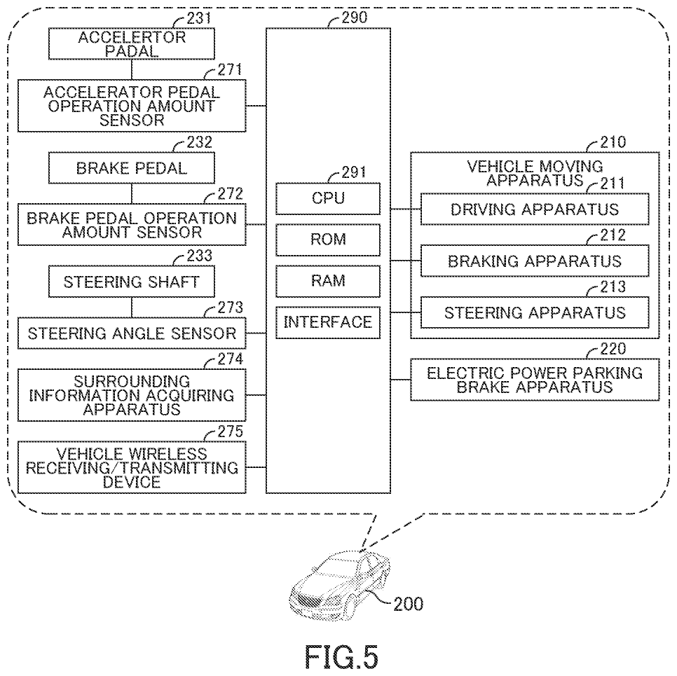

As shown in FIG. 5, a vehicle moving apparatus 210, an electric power parking brake apparatus 220, and the vehicle ECU 290 are installed on the vehicle 200.

The vehicle ECU 290 includes a micro-computer as a main component. The vehicle ECU 290 includes a CPU, a ROM, a RAM, a non-volatile memory, and an interface. Hereinafter, the CPU of the vehicle ECU 290 will be referred to as “vehicle CPU 291”. The vehicle CPU 291 is configured or programmed to realize various functions by executing instructions, or programs, or routines memorized in the ROM. In particular, programs of executing the remote parking/pulling-out control described later is memorized in the vehicle ECU 290.

When the remote moving system 10 is configured as shown in FIG. 3, the remote moving system 10 may be configured such that programs stored in the server 301 realizes a part of functions realized by the programs of executing the remote parking/pulling-out control memorized in the vehicle ECU 290. Further, when the remote moving system 10 is configured as shown in FIG. 3, the remote moving system 10 may be configured such that the programs of executing the remote parking/pulling-out control memorized in the vehicle ECU 290 is updated by the server 301.

<Vehicle Moving Apparatus>

The vehicle moving apparatus 210 includes a driving apparatus 211, a braking apparatus 212, and a steering apparatus 213.

<Driving Apparatus>

The driving apparatus 211 is an apparatus which outputs a force to be applied to the vehicle 200 to move the vehicle 200. The driving apparatus 211 is, for example, an internal combustion engine and at least one electric motor. The driving apparatus 211 is electrically connected to the vehicle ECU 290. The vehicle ECU 290 can control the driving force output from the driving apparatus 211 by controlling activations of the driving apparatus 211.

<Braking Apparatus>

The braking apparatus 212 is an apparatus which outputs a braking force to be applied to the vehicle 200 to brake the vehicle 200. The braking apparatus 212 is, for example, a brake apparatus. The braking apparatus 212 is electrically connected to the vehicle ECU 290. The vehicle ECU 290 can control the braking force output from the braking apparatus 212 by controlling activations of the braking apparatus 212.

<Steering Apparatus>

The steering apparatus 213 is an apparatus which outputs a steering force to be applied to the vehicle 200 to steer the vehicle 200. The braking apparatus 212 is, for example, a power steering apparatus. The steering apparatus 213 is electrically connected to the vehicle ECU 290. The vehicle ECU 290 can control the steering force output from the steering apparatus 213 by controlling activations of the steering apparatus 213.

As described above, the vehicle moving apparatus 210 is an apparatus which drives, brakes, and steers the vehicle 200. Further, the vehicle ECU 290 is a device which controls activations of the vehicle moving apparatus 210.

<Electric Parking Brake Apparatus>

The electric power parking brake apparatus 220 is an apparatus which holds the vehicle 200 stopped by locking wheels of the stopped vehicle 200. The electric power parking brake apparatus 220 is electrically connected to the vehicle ECU 290. The vehicle ECU 290 can lock the wheels of the stopped vehicle 200 by activating the electric power parking brake apparatus 220.

<Surrounding Information Acquiring Apparatus, etc.>

Further, an accelerator pedal 231, an accelerator pedal operation amount sensor 271, a brake pedal 232, a brake pedal operation amount sensor 272, a steering shaft 233, a steering angle sensor 273, a surrounding information acquiring apparatus 274, and a vehicle wireless receiving/transmitting device 275 are installed on the vehicle 200.

<Accelerator Pedal Operation Amount Sensor>

The accelerator pedal operation amount sensor 271 is a sensor which detects an operation amount of the accelerator pedal 231. The accelerator pedal operation amount sensor 271 is electrically connected to the vehicle ECU 290. The accelerator pedal operation amount sensor 271 sends information on the detected operation amount of the accelerator pedal 231 to the vehicle ECU 290. The vehicle ECU 290 acquires the operation amount of the accelerator pedal 231 as an accelerator pedal operation amount AP, based on the information sent from the accelerator pedal operation amount sensor 271.

The vehicle ECU 290 acquires a requested driving force or a requested driving torque by calculation, based on the accelerator pedal operation amount AP and a vehicle moving speed of the vehicle 200. The requested driving force is a driving force which is requested to be output from the driving apparatus 211. The vehicle ECU 290 controls the activations of the driving apparatus 211 so as to output the driving force which corresponds to the requested driving force, from the driving apparatus 211. Further the vehicle ECU 290 (i) determines the requested driving force which is needed to move the vehicle 200 in the remote parking/pulling-out control described later and (ii) controls the activations of the driving apparatus 211 so as to output the driving force which corresponds to the requested driving force, from the driving apparatus 211.

<Brake Pedal Operation Amount Sensor>

The brake pedal operation amount sensor 272 is a sensor which detects an operation amount of the brake pedal 232. The brake pedal operation amount sensor 272 is electrically connected to the vehicle ECU 290. The brake pedal operation amount sensor 272 sends information on the detected operation amount of the brake pedal 232 to the vehicle ECU 290. The vehicle ECU 290 acquires the operation amount of the brake pedal 232 as a brake pedal operation amount BP, based on the information sent from the brake pedal operation amount sensor 272.

The vehicle ECU 290 acquires a requested braking force or a requested braking torque by calculation, based on the brake pedal operation amount BR The requested braking force is a braking force which is requested to be output from the braking apparatus 212. The vehicle ECU 290 controls the activations of the braking apparatus 212 so as to output the braking force which corresponds to the requested braking force, from the braking apparatus 212. Further the vehicle ECU 290 (i) determines the requested braking force which is needed to brake the vehicle 200 in the remote parking/pulling-out control described later and (ii) controls the activations of the braking apparatus 212 so as to output the braking force which corresponds to the requested braking force, from the braking apparatus 212.

<Steering Angle Sensor>

The steering angle sensor 273 is a sensor which detects a rotation angle of the steering shaft 233 with respect to a neutral position. The steering angle sensor 273 is electrically connected to the vehicle ECU 290. The steering angle sensor 273 sends information on the detected rotation angle of the steering shaft 233 to the vehicle ECU 290. The vehicle ECU 290 acquires the rotation angle of the steering shaft 233 as a steering angle θ, based on the information sent from the steering angle sensor 273.

The vehicle ECU 290 acquires a requested steering force or a requested steering torque by calculation, based on the steering angle θ. The requested steering force is a steering force which is requested to be output from the steering apparatus 213. The vehicle ECU 290 controls the activations of the steering apparatus 213 so as to output the steering force which corresponds to the requested steering force, from the steering apparatus 213. Further the vehicle ECU 290 (i) determines the requested steering force which is needed to steer the vehicle 200 in the remote parking/pulling-out control described later and (ii) controls the activations of the steering apparatus 213 so as to output the steering force which corresponds to the requested steering force, from the steering apparatus 213.

<Surrounding Information Acquiring Apparatus>

The surrounding information acquiring apparatus 274 is an apparatus which acquires information on surroundings of the vehicle 200. The surrounding information acquiring apparatus 274 is, for example, cameras, radar sensors such as millimeter wave sensors, ultrasonic wave sensors such as clearance sonars, and laser radars such as LIDARs.

The surrounding information acquiring apparatus 274 is electrically connected to the vehicle

ECU 290. The surrounding information acquiring apparatus 274 sends information on the acquired information on the surroundings of the vehicle 200 to the vehicle ECU 290. Hereinafter, the information on the surroundings of the vehicle 200 will be referred to as “surrounding information INF”. The vehicle ECU 290 can acquire various information on the surroundings of the operation terminal 100, based on the surrounding information INF sent from the surrounding information acquiring apparatus 274.

<Vehicle Wireless Receiving/Transmitting Device>

The vehicle wireless receiving/transmitting device 275 is electrically connected to the vehicle ECU 290. The vehicle ECU 290 can transmit various signals to the outside of the vehicle 200 via the vehicle wireless receiving/transmitting device 275. In addition, the vehicle ECU 290 can receive various signals which the terminal ECU 190 transmits to the outside of the operation terminal 100 via the terminal wireless receiving/transmitting device 120, via the vehicle wireless receiving/transmitting device 275.

<Summary of Operations of Remote Moving System>

Next, a summary of operations of the remote moving system 10 will be described. As described above, the remote moving system 10 is a system which (i) remotely moves and parks the vehicle 200 in the parking space with the operation terminal 100 outside of the vehicle 200 and (ii) remotely moves and pulls out the vehicle 200 from the parking space with the operation terminal 100 outside of the vehicle 200.

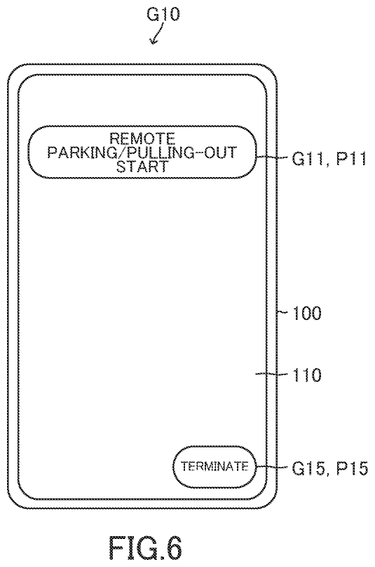

When a predetermined touch interaction of starting up the remote moving application is applied to the display 110, the terminal ECU 190 starts up the remote moving application and displays an initial display image G10 on the display 110 as shown in FIG. 6. The touch interaction is a contact interaction or a contact operation that a user of the operation terminal 100 touches or contacts the display 110.

The initial display image G10 includes a remote parking/pulling-out starting image G11 and an application terminating image G15. The remote parking/pulling-out starting image G11 is an image which displays letters “REMOTE PARKING/PULL-OUT START”. The application terminating image G15 is an image which displays a letter “TERMINATE”. A portion of the display 110 which displays the remote parking/pulling-out starting image G11 is a portion which accepts the touch interaction carried out by the user. Hereinafter, the portion of the display 110 which displays the remote parking/pulling-out starting image G11 will be referred to as “remote parking/pulling-out starting image portion P11”. A portion of the display 110 which displays the application terminating image G15 is also a portion which accepts the touch interaction carried out by the user. Hereinafter, the portion of the display 110 which displays the application terminating image G15 will be referred to as “application terminating image portion P15”.

In addition, when the predetermined touch interaction of starting up the remote moving application is applied to the display 110, the terminal ECU 190 transmits an application started-up signal S10 to the outside. The application started-up signal S10 is a signal which represents information on an ID which is used to identify the operation terminal 100.

When the vehicle ECU 290 receives the application started-up signal S10, the vehicle ECU 290 determines whether the operation terminal 100 which is represented by the application started-up signal S10, is a registered operation terminal. The registered operation terminal is an operation terminal which is registered in the vehicle ECU 290 as an operation terminal used to cause the vehicle ECU 290 to execute the remote parking/pulling-out control.

In this embodiment, the operation terminal 100 is the registered operation terminal. Thus, when the vehicle ECU 290 receives the application started-up signal S10, the vehicle ECU 290 determines that the operation terminal 100 is the registered operation terminal. In this case, the vehicle ECU 290 executes the remote parking/pulling-out control, based on various signals which are transmitted from the operation terminal 100 to the outside.

After the vehicle ECU 290 determines that the operation terminal 100 is the registered operation terminal, the vehicle ECU 290 activates vehicle moving equipment such as the surrounding information acquiring apparatus 274 and the vehicle moving apparatus 210 or causes the vehicle moving equipment to be ready to activate.

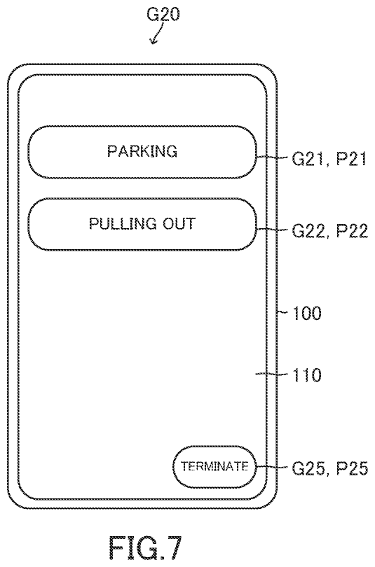

When the touch interaction is applied to the remote parking/pulling-out starting image portion P11, the terminal ECU 190 displays a parking/pulling-out selecting image G20 as shown in FIG. 7. The effective touch interaction to be applied to the remote parking/pulling-out starting image portion P11 is any one of (i) a swiping interaction or a swiping operation, (ii) a sliding interaction or a sliding operation, (iii) a long-pressing interaction or a long-pressing operation, (iv) a tapping interaction or a tapping operation, (v) an interaction or an operation of drawing the predetermined line, (vi) an interaction or an operation of inputting numbers, and (vii) a continuous touch interaction or a continuous touch operation. In this embodiment, the effective touch interaction to be applied to the remote parking/pulling-out starting image portion P11 is the swiping interaction. The swiping interaction is a kind of the sliding interaction. The swiping interaction is one of touch interactions of sliding the finger straight in a constant direction on the display 110. Also, the swiping interaction is one of sliding touch interactions.

The parking/pulling-out selecting image G20 includes a parking selecting image G21, a pulling-out selecting image G22, and an application terminating image G25. The parking selecting image G21 is an image which displays a letter “PARKING”. The pulling-out selecting image G22 is an image which display letters “PULLING OUT”. The application terminating image G25 is an image which displays a letter “TERMINATE”.

A portion of the display 110 which displays the parking selecting image G21 is a portion which accepts the touch interaction carried out by the user. Hereinafter, the portion of the display 110 which displays the parking selecting image G21 will be referred to as “parking selecting image portion P21”. A portion of the display 110 which displays the pulling-out selecting image G22 and a portion of the display 110 which displays the application terminating image G25 are also portions which accept the touch interactions carried out by the user. Hereinafter, the portion of the display 110 which displays the pulling-out selecting image G22 will be referred to as “pulling-out selecting image portion P22”, and the portion of the display 110 which displays the application terminating image G25 will be referred to as “application terminating image portion P25”.

<Remote Parking Control>

When the touch interaction is applied to the parking selecting image portion P21, the terminal ECU 190 transmits a parking selected signal S11 to the outside. The effective touch interaction to be applied to the parking selecting image portion P21 is any one of (i) the swiping interaction, (ii) the sliding interaction, (iii) the long-pressing interaction, (iv) the tapping interaction, (v) the interaction of drawing the predetermined line, (vi) the interaction of inputting the numbers, and (vii) the continuous touch interaction as far as a type of the effective touch interaction to be applied to the parking selecting image portion P21 is different from a type of the effective touch interaction to be applied to the remote parking/pulling-out starting image portion P11. In this embodiment, the effective touch interaction to be applied to the parking selecting image portion P21 is the tapping interaction. The tapping interaction is one of touch interactions of tapping the display 110 with the finger. The parking selected signal S11 is a signal which represents that the tapping interaction is applied to the parking selecting image portion P21.

When the vehicle ECU 290 receives the parking selected signal S11, the vehicle ECU 290 transmits a parking space signal S12 and a vehicle position signal S13 to the outside. The parking space signal S12 is a signal which represents information on parking spaces in which the vehicle 200 can be parked. The information on the parking spaces in which the vehicle 200 can be parked is acquired, based on the surrounding information INF. The vehicle position signal S13 is a signal which represents information on the position of the vehicle 200 with respect to the parking spaces in which the vehicle 200 can be parked.

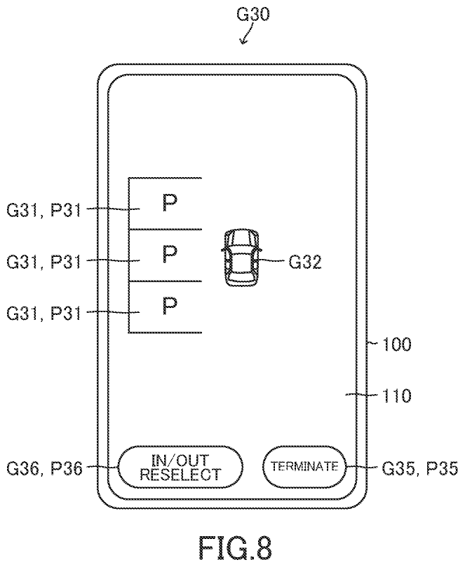

When the terminal ECU 190 receives the parking space signal S12 and the vehicle position signal S13, the terminal ECU 190 displays a parking space selecting image G30 on the display 110 as shown in FIG. 8. The parking space selecting image G30 includes at least one (in an example shown in FIG. 8, three) candidate parking space image G31, a vehicle image G32, an application terminating image G35, and a parking/pulling-out reselecting image G36. The candidate parking space image G31 is an image which displays candidates of the parking spaces to park the vehicle 200. The vehicle image G32 is an image which displays the vehicle 200. The application terminating image G35 is an image which displays a letter “TERMINATE”. The parking/pulling-out reselecting image G36 is an image which displays letters “IN/OUT RESELECT”.

A portion of the display 110 which displays the candidate parking space image G31 is a portion which accepts the touch interaction carried out by the user. Hereinafter, the portion of the display 110 which displays the candidate parking space image G31 will be referred to as “candidate parking space selecting image portion P31”. A portion of the display 110 which displays the application terminating image G35 and a portion of the display 110 which displays the parking/pulling-out reselecting image G36 are also portions which accept the touch interactions carried out by the user. Hereinafter, the portion of the display 110 which displays the application terminating image G35 will be referred to as “application terminating image portion P35”, and the portion of the display 110 which displays the parking/pulling-out reselecting image G36 will be referred to as “parking/pulling-out reselecting image portion P36”.

When the touch interaction is applied to any one of the candidate parking space image portions P31, the terminal ECU 190 transmits a parking space signal S14 to the outside. The effective touch interaction to be applied to the candidate parking space image portion P31 is any one of (i) the swiping interaction, (ii) the sliding interaction, (iii) the long-pressing interaction, (iv) the tapping interaction, (v) the interaction of drawing the predetermined line, (vi) the interaction of inputting the numbers, and (vii) the continuous touch interaction as far as a type of the effective touch interaction to be applied to the candidate parking space image portion P31 is different from a type of the effective touch interaction to be applied to the parking selecting image portion P21. In this embodiment, the effective touch interaction to be applied to the candidate parking space image portion P31 is the long-pressing interaction. The long-pressing interaction may be called “long-tapping interaction”. The long-pressing interaction is one of touch interactions of touching the display 110 with finger fora relatively long constant time. The parking space signal S14 is a signal which represents the candidate parking space image portion P31 to which the tapping interaction is applied.

When the vehicle ECU 290 receives the parking space signal S14, the vehicle ECU 290 starts executing the remote parking control and calculates a parking route. The parking route is a predetermined route along which the remote parking control moves and parks the vehicle 200 in the parking space which is represented by the parking space signal S14. Hereinafter, the parking space which is represented by the parking space signal S14 will be referred to as “target parking space Pin_tgt.

When the vehicle ECU 290 calculates the parking route, the vehicle ECU 290 transmits a parking remaining distance signal S15 to the outside. The parking remaining distance signal S15 is a signal which represents a distance between the target parking space Pin_tgt and the vehicle 200. Hereinafter, the distance between the target parking space Pin_tgt and the vehicle 200 will be referred to as “parking remaining distance Din”. The vehicle ECU 290 acquires the parking remaining distance Din by calculation, based on the surrounding information INF.

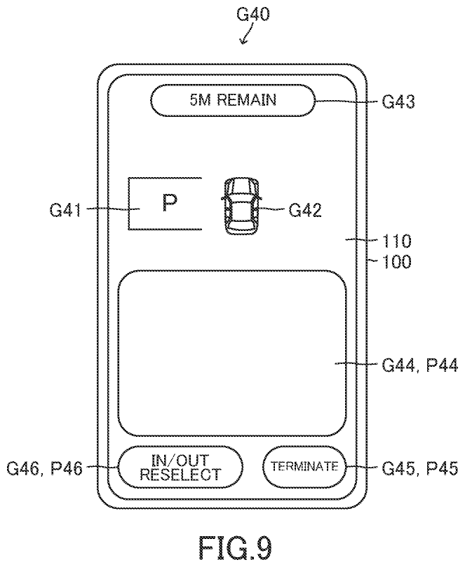

Further, when the long-pressing interaction is applied to any one of the candidate parking space image portions P31, the terminal ECU 190 displays a parking interacting image G40 (or a parking operating image) on the display 110 as shown in FIG. 9. The parking interacting image G40 includes a target parking space image G41, a vehicle image G42, a parking remaining distance image G43, a parking moving interacting image G44 (or a parking moving operating image), an application terminating image G45, and a parking/pulling-out reselecting image G46.

The target parking space image G41 is an image which displays the target parking space Pin_tgt. The vehicle image G42 is an image which displays the vehicle 200. The parking remaining distance image G43 is an image which displays the parking remaining distance Din. The parking moving interacting image G44 is an image which defines an area which has a predetermined area. The application terminating image G45 is an image which displays a letter “TERMINATE”. The parking/pulling-out reselecting image G46 is an image which displays letters “IN/OUT RESELECT”.

A portion of the display 110 which displays the parking moving interacting image G44 is a portion which accepts the touch interactions carried out by the user. Hereinafter, the portion of the display 110 which displays the parking moving interacting image G44 will be referred to as “parking moving interacting image portion P44”. A portion of the display 110 which displays the application terminating image G45 and a portion of the display 110 which displays the parking/pulling-out reselecting image G46 are also portions which accept the touch interactions carried out by the user. Hereinafter, the portion of the display 110 which displays the application terminating image G45 will be referred to as “application terminating image portion P45”, and the portion of the display 110 which displays the parking/pulling-out reselecting image G46 will be referred to as “parking/pulling-out reselecting image portion P46”.

When the terminal ECU 190 receives the parking remaining distance signal S15, the terminal ECU 190 acquires the parking remaining distance Din which the parking remaining distance signal S15 represents, and displays the parking remaining distance image G43 which displays the acquired parking remaining distance Din on the display 110.

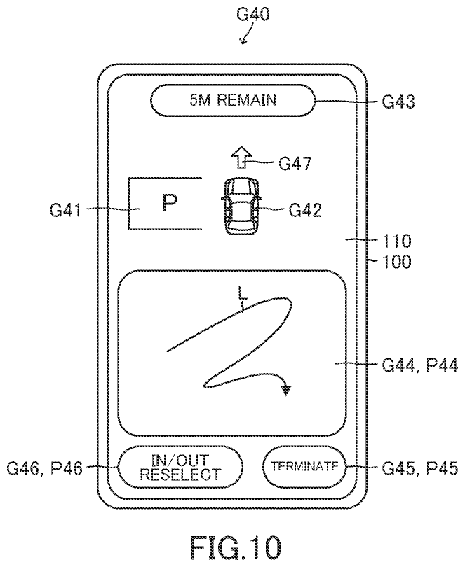

Then, the terminal ECU 190 transmits a parking moving commanding signal S16 while the touch interactions are applied to the parking moving interacting image portion P44. The effective touch interaction to be applied to the parking moving interacting image portion P44 is any one of (i) the swiping interaction, (ii) the sliding interaction, (iii) the long-pressing interaction, (iv) the tapping interaction, (v) the interaction of drawing the predetermined line, (vi) the interaction of inputting the numbers, and (vii) the continuous touch interaction as far as a type of the effective touch interaction to be applied to the parking moving interacting image portion P44 is different from a type of the effective touch interaction to be applied to the candidate parking space image portion P31. In this embodiment, the effective touch interaction to be applied to the parking moving interacting image portion P44 is the continuous touch interaction. The continuous touch interaction in question is a kind of the sliding interaction. The continuous touch interaction in question is an interaction of sliding the finger on the parking moving interacting image portion P44. The terminal ECU 190 can be configured to recognize the touch interaction of drawing a line which has a predetermined shape such as an arc shape, a wave shape, or a straight shape, as the continuous touch interaction. However, the terminal ECU 190 of this embodiment is configured to recognize the touch interaction of drawing a line having any shapes as shown by a line L in FIG. 10, as the continuous touch interaction. The parking moving commanding signal S16 is a signal which represents that the continuous touch interaction is applied to the parking moving interacting image portion P44.

After the vehicle ECU 290 calculates the parking route, the vehicle ECU 290 controls the activations of the vehicle moving apparatus 210 so as to move the vehicle 200 along the parking route to the target parking space Pin_tgt while the vehicle ECU 290 receives the parking moving commanding signal S16. Further, the vehicle ECU 290 continuously transmits the vehicle position signal S13, the parking remaining distance signal S15, and a moving direction signal S17 to the outside while the vehicle ECU 290 is executing the remote parking control. The moving direction signal S17 is a signal which represents a moving direction of the vehicle 200.

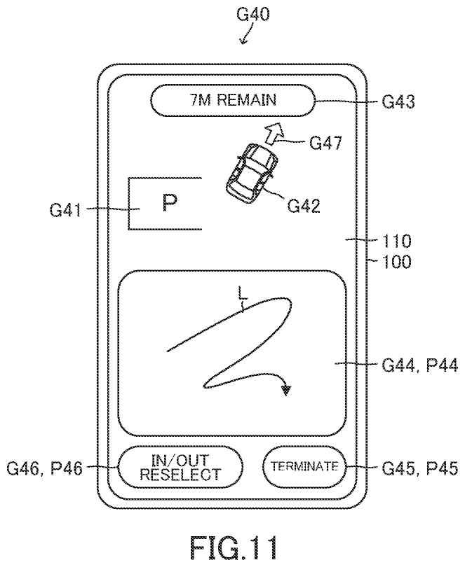

When the terminal ECU 190 receives the vehicle position signal S13, the terminal ECU 190 displays the vehicle image G42 at a portion of the display 110 which corresponds to the position of the vehicle 200 with respect to the target parking space Pin_tgt which the vehicle position signal S13 represents as shown in FIG. 11. In addition, when the terminal ECU 190 receives the parking remaining distance signal S15, the terminal ECU 190 displays the parking remaining distance image G43 on the display 110 which displays the parking remaining distance Din which the parking remaining distance signal S15 represents. In addition, when the terminal ECU 190 receives the moving direction signal S17, the terminal ECU 190 displays a moving direction image G47 at a portion of the display 110 near the vehicle image G42. The moving direction image G47 is an image which displays the moving direction of the vehicle 200 which the moving direction signal S17 represents.

When the user puts off his/her finger from the parking moving interacting image portion P44, the terminal ECU 190 stops transmitting the parking moving commanding signal S16 to the outside. Thereby, the vehicle ECU 290 does not receive the parking moving commanding signal S16. When the vehicle ECU 290 does not receive the parking moving commanding signal S16, the vehicle ECU 290 stops the vehicle 200 by the braking apparatus 212.

When the vehicle 200 reaches the target parking space Pin_tgt and has been parked, the vehicle ECU 290 locks the wheels of the vehicle 200 by the electric power parking brake apparatus 220 and stops the activations of the vehicle moving equipment such as the surrounding information acquiring apparatus 274 and the vehicle moving apparatus 210 to terminate executing the remote parking control. In addition, when the vehicle 200 has been parked, the vehicle ECU 290 transmits a parking completed signal S18 to the outside. The parking completed signal S18 is a signal which represents that the vehicle 200 has been parked.

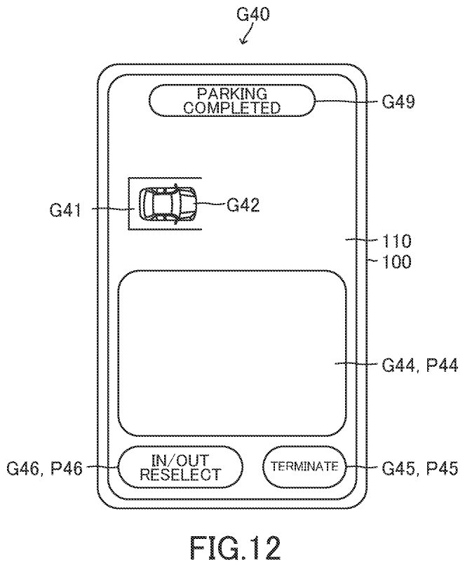

When the terminal ECU 190 receives the parking completed signal S18, the terminal ECU 190 displays a parking completed image G49 as shown in FIG. 12. The parking completed image G49 is an image which display that the vehicle 200 has been parked.

<Remote Pulling-Out Control>

When the touch interaction is applied to the pulling-out selecting image portion P22, the terminal ECU 190 transmits a pulling-out selected signal S21 to the outside. The effective touch interaction to be applied to the pulling-out selecting image portion P22 is any one of (i) the swiping interaction, (ii) the sliding interaction, (iii) the long-pressing interaction, (iv) the tapping interaction, (v) the interaction of drawing the predetermined line, (vi) the interaction of inputting the numbers, and (vii) the continuous touch interaction as far as a type of the effective touch interaction to be applied to the pulling-out selecting image portion P22 is different from a type of the effective touch interaction to be applied to the remote parking/pulling-out starting image portion P11. In this embodiment, the effective touch interaction to be applied to the pulling-out selecting image portion P22 is the tapping interaction. The pulling-out selected signal S21 is a signal which represents that the tapping interaction is applied to the pulling-out selecting image portion P22.

When the vehicle ECU 290 receives the pulling-out selected signal S21, the vehicle ECU 290 transmits a vehicle position signal S23 to the outside. The vehicle position signal S23 is a signal which represents information on the position of the vehicle 200 with respect to the parking space in which the vehicle 200 has been parked. The information on the position of the vehicle 200 with respect to the parking space in which the vehicle 200 has been parked, is acquired, based on the surrounding information INF.

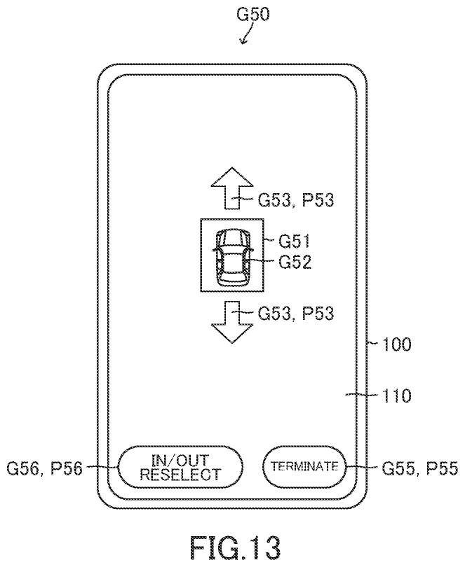

When the terminal ECU 190 receives the vehicle position signal S23, the terminal ECU 190 displays a pulling-out direction selecting image G50 on the display 110 as shown in FIG. 13.

The pulling-out direction selecting image G50 includes a current parking space image G51, a vehicle image G52, at least one (in an example shown in FIG. 13, two) candidate pulling-out direction image G53, an application terminating image G55, and a parking/pulling-out reselecting image G56. The current parking space image G51 is an image which displays the parking space in which the vehicle 200 has been parked. Hereinafter, the parking space in which the vehicle 200 has been parked, will be referred to as “current parking space Pnow”. The vehicle image G52 is an image which displays the vehicle 200. The candidate pulling-out direction image G53 is an image which displays candidates of a pulling-out direction of pulling out the vehicle 200. The application terminating image G55 is an image which displays a letter “TERMINATE”. The parking/pulling-out reselecting image G56 is an image which displays letters “IN/OUT RESELECT”.

A portion of the display 110 which displays the candidate pulling-out direction image G53 is a portion which accepts the touch interaction carried out by the user. Hereinafter, the portion of the display 110 which displays the candidate pulling-out direction image G53 will be referred to as “candidate pulling-out direction image portion P51”. A portion of the display 110 which displays the application terminating image G55 and a portion of the display 110 which displays the parking/pulling-out reselecting image G56 are also portions which accept the touch interactions carried out by the user. Hereinafter, the portion of the display 110 which displays the application terminating image G55 will be referred to as “application terminating image portion P55”, and the portion of the display 110 which displays the parking/pulling-out reselecting image G56 will be referred to as “parking/pulling-out reselecting image portion P56”.

When the touch interaction is applied to any one of the candidate pulling-out direction image portions P53, the terminal ECU 190 transmits a pulling-out direction signal S22 to the outside. The effective touch interaction to be applied to the candidate pulling-out direction image portion P53 is any one of (i) the swiping interaction, (ii) the sliding interaction, (iii) the long-pressing interaction, (iv) the tapping interaction, (v) the interaction of drawing the predetermined line, (vi) the interaction of inputting the numbers, and (vii) the continuous touch interaction as far as a type of the effective touch interaction to be applied to the candidate pulling-out direction image portion P53 is different from a type of the effective touch interaction to be applied to the pulling-out selecting image portion P22. In this embodiment, the effective touch interaction to be applied to the candidate pulling-out direction image portion P53 is the long-pressing interaction. The pulling-out direction signal S22 is a signal which represents the candidate pulling-out direction image portion P53 to which the long-pressing interaction is applied.

When the vehicle ECU 290 receives the pulling-out direction signal S22, the vehicle ECU 290 starts executing the remote pulling-out control and calculates a pulling-out route. The pulling-out route is a predetermined route along which the remote pulling-out control moves the vehicle 200 in the pulling-out direction which the pulling-out direction signal S22 represents and moves the vehicle 200 to a target pulling-out point Pout_tgt.

When the vehicle ECU 290 calculates the pulling-out route, the vehicle ECU 290 transmits a pulling-out remaining distance signal S25 to the outside. The pulling-out remaining distance signal S25 is a signal which represents a distance between the target pulling-out point Pout_tgt and the vehicle 200. Hereinafter, the distance between the target pulling-out point Pout_tgt and the vehicle 200 will be referred to as “pulling-out remaining distance Dout”. The vehicle ECU 290 acquires the pulling-out remaining distance Dout by calculation, based on the surrounding information INF.

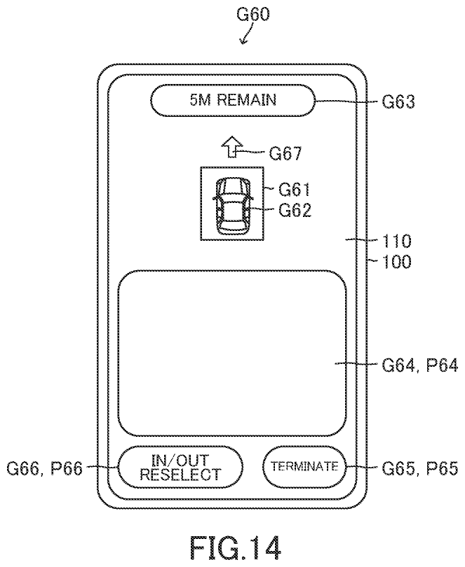

Further, when the long-pressing interaction is applied to any one of the candidate pulling-out direction image portions P53, the terminal ECU 190 displays a pulling-out interacting image G60 (or a pulling-out operating image) on the display 110 as shown in FIG. 14. FIG. 14 shows an example that the pulling-out direction which the user selects, is a direction that the vehicle 200 is moved forward.

The pulling-out interacting image G60 includes a current parking space image G61, a vehicle image G62, a pulling-out remaining distance image G63, a pulling-out moving interacting image G64 (or a pulling-out operating image), an application terminating image G65, a parking/pulling-out reselecting image G66, and a pulling-out direction image G67.

The current parking space image G61 is an image which displays the current parking space Pnow. The vehicle image G62 is an image which displays the vehicle 200. The pulling-out remaining distance image G63 is an image which displays the pulling-out remaining distance Dout. The pulling-out moving interacting image G64 is an image which defines an area which has a predetermined area. The application terminating image G65 is an image which displays a letter “TERMINATE”. The parking/pulling-out reselecting image G66 is an image which displays letters “IN/OUT RESELECT”. The pulling-out direction image G67 is an image which displays the pulling-out direction which the user selects.

A portion of the display 110 which displays the pulling-out moving interacting image G64 is a portion which accepts the touch interactions carried out by the user. Hereinafter, the portion of the display 110 which displays the pulling-out moving interacting image G64 will be referred to as “pulling-out moving interacting image portion P64”. A portion of the display 110 which displays the application terminating image G65 and a portion of the display 110 which displays the parking/pulling-out reselecting image G66 are also portions which accept the touch interactions carried out by the user. Hereinafter, the portion of the display 110 which displays the application terminating image G65 will be referred to as “application terminating image portion P65”, and the portion of the display 110 which displays the parking/pulling-out reselecting image G66 will be referred to as “parking/pulling-out reselecting image portion P66”.

When the terminal ECU 190 receives the pulling-out remaining distance signal S25, the terminal ECU 190 acquires the pulling-out remaining distance Dout which the pulling-out remaining distance signal S25 represents, and displays the pulling-out remaining distance image G63 which displays the acquired parking remaining distance Dout on the display 110.

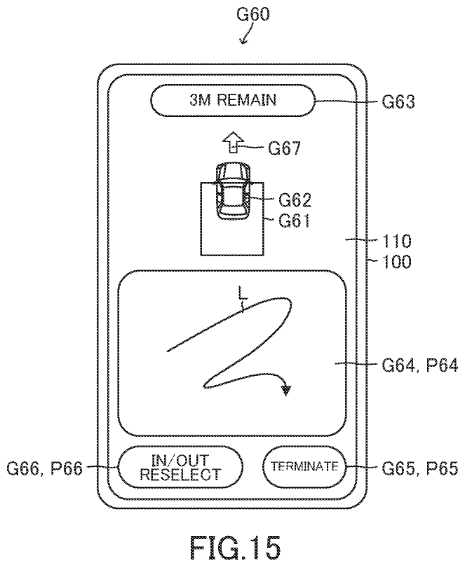

Then, the terminal ECU 190 transmits a pulling-out moving commanding signal S26 while the continuous touch interactions are applied to the pulling-out moving interacting image portion P64. The effective touch interaction to be applied to the pulling-out moving interacting image portion P64 is any one of (i) the swiping interaction, (ii) the sliding interaction, (iii) the long-pressing interaction, (iv) the tapping interaction, (v) the interaction of drawing the predetermined line, (vi) the interaction of inputting the numbers, and (vii) the continuous touch interaction as far as a type of the effective touch interaction to be applied to the pulling-out moving interacting image portion P64 is different from a type of the effective touch interaction to be applied to the candidate pulling-out direction image portion P53. In this embodiment, the effective touch interaction to be applied to the pulling-out moving interacting image portion P64 is the continuous touch interaction. The continuous touch interaction in question is a kind of the sliding interaction. The continuous touch interaction in question is an interaction of sliding the finger on the pulling-out moving interacting image portion P64. The terminal ECU 190 can be configured to recognize the touch interaction of drawing a line which has a predetermined shape such as the arc shape, the wave shape, or the straight shape, as the continuous touch interaction. However, the terminal ECU 190 of this embodiment is configured to recognize the touch interaction of drawing a line having any shape as shown by a line L in FIG. 15, as the continuous touch interaction. The pulling-out moving commanding signal S26 is a signal which represents that the continuous touch interaction is applied to the pulling-out moving interacting image portion P64.

After the vehicle ECU 290 calculates the pulling-out route, the vehicle ECU 290 controls the activations of the vehicle moving apparatus 210 so as to move the vehicle 200 along the pulling-out route to the target pulling-out point Pout_tgt while the vehicle ECU 290 receives the pulling-out moving commanding signal S26. Further, the vehicle ECU 290 continuously transmits the vehicle position signal S23 and the pulling-out remaining distance signal S25 to the outside while the vehicle ECU 290 is executing the remote pulling-out control.

When the terminal ECU 190 receives the vehicle position signal S23, the terminal ECU 190 displays the vehicle image G62 at a portion of the display 110 which corresponds to the position of the vehicle 200 with respect to the current parking space Pnow which the vehicle position signal S23 represents as shown in FIG. 14. In addition, when the terminal ECU 190 receives the pulling-out remaining distance signal S25, the terminal ECU 190 displays the pulling-out remaining distance image G63 on the display 110 which displays the pulling-out remaining distance Dout which the pulling-out remaining distance signal S25 represents.

When the user puts off his/her finger from the pulling-out moving interacting image portion P64, the terminal ECU 190 stops transmitting the pulling-out moving commanding signal S26 to the outside. Thereby, the vehicle ECU 290 does not receive the pulling-out moving commanding signal S26. When the vehicle ECU 290 does not receive the pulling-out moving commanding signal S26, the vehicle ECU 290 stops the vehicle 200 by the braking apparatus 212.

When the vehicle 200 reaches the target pulling-out point Pout_tgt and has been pulled out, the vehicle ECU 290 locks the wheels of the vehicle 200 by the electric power parking brake apparatus 220 and stops the activations of the vehicle moving equipment such as the surrounding information acquiring apparatus 274 and the vehicle moving apparatus 210 to terminate executing the remote pulling-out control. In addition, when the vehicle 200 has been pulled out, the vehicle ECU 290 transmits a pulling-out completed signal S28 to the outside. The pulling-out completed signal S28 is a signal which represents that the vehicle 200 has been pulled out.

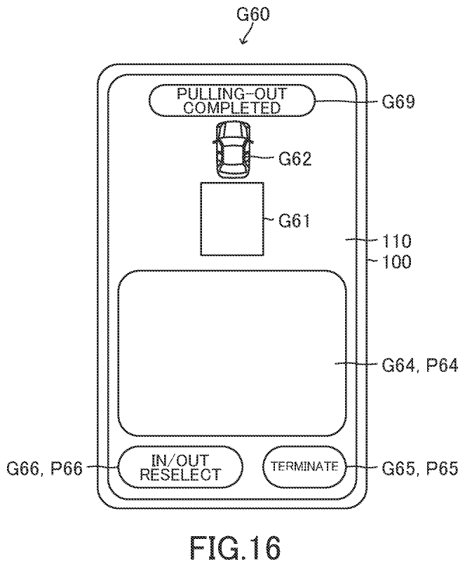

When the terminal ECU 190 receives the pulling-out completed signal S28, the terminal ECU 190 displays a pulling-out completed image G69 as shown in FIG. 16. The pulling-out completed image G69 is an image which display that the vehicle 200 has been pulled out.

<Terminating Application, etc.>

When the tapping interaction is applied to the application terminating image portion P15 or the like (i.e., the application terminating image portion P15, P25, P35, P45, P55, or P65), the terminal ECU 190 terminates executing the remote moving application and transmits a control terminating commanding signal S30. The control terminating commanding signal S30 is a signal which commands to terminate executing the remote parking/pulling-out control.

Further, when the tapping interaction is applied to the parking/pulling-out reselecting image portion P36 or the like (i.e., the parking/pulling-out reselecting image portion P36, P46, P56, or P66), the terminal ECU 190 displays the parking/pulling-out selecting image G20 on the display 110 and transmits the control terminating commanding signal S30.

When the vehicle ECU 290 receives the control terminating commanding signal S30, the vehicle ECU 290 stops the vehicle 200 by the braking apparatus 212 and then, locks the wheels of the vehicle 200 by the electric power parking brake apparatus 220, stops activating the vehicle moving equipment such as the surrounding information acquiring apparatus 274 and the vehicle moving apparatus 210, and terminates executing the remote parking control or the remote pulling-out control.

<Effects>

If the operation terminal 100 is in a pocket of a shirt or a bag of the user, a cloth of the shirt or a leather of the bag may constantly contact the display 110 of the operation terminal 100.

Thus, the touch interaction (a first interaction or a first operation) of changing a state of the operation terminal 100 from a state (a first state) that the operation terminal 100 displays the parking space selecting image G30, to a state (a second state) that the operation terminal 100 displays the parking interacting image G40, may be applied to the display 110 by the cloth or the leather. Then, the touch interaction (a second interaction or a second operation) of causing the operation terminal 100 to transmit the parking moving commanding signal S16 or the pulling-out moving commanding signal S26 (i.e., a signal which commands to move the vehicle 200) may be applied to the display 110 by the cloth or the leather. In this case, the state of the operation terminal 100 is changed from the first state (i.e., a state that the parking space selecting image G30 is displayed) to the second state (i.e., a state that the parking interacting image G40 is displayed) by the cloth or the leather contacting the display 110, and the signal of commanding to move the vehicle 200 (i.e., the parking moving commanding signal S16 or the pulling-out moving commanding signal S26) is transmitted. In this case, the vehicle 200 is unintentionally moved.

According to the remote moving system 10, the touch interaction (the first interaction) effective to change the state of the operation terminal 100 from the first state (i.e., the state that the parking space selecting image G30 is displayed) to the second state (the state that the parking interacting image G40 is displayed), is the long-pressing interaction. Further, the touch interaction (the second interaction) effective to cause the operation terminal 100 to transmit the signal of commanding to move the vehicle 200 (i.e., the parking moving commanding signal S16 or the pulling-out moving commanding signal S26), is the continuous long-pressing interaction.

Thus, the first interaction and the second interaction are different from each other. Thus, even when the cloth of the shirt or the leather of the bag constantly contacts the display 110, the signal of commanding to move the vehicle 200 is unlikely to be transmitted. Thus, the remote pulling-out control can be prevented from moving the vehicle without user's intention.

<Specific Operations of Remote Moving System>

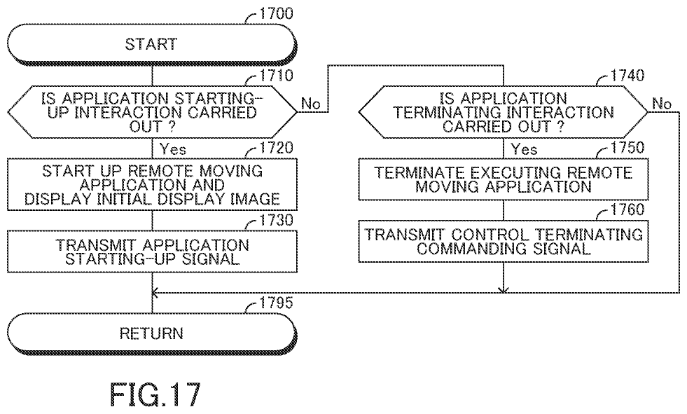

Next, specific operations of the remote moving system 10 will be described. The terminal CPU 191 of the remote moving system 10 is configured or programmed to execute a routine shown in FIG. 17 each time a predetermined calculation time elapses. Therefore, at a predetermined timing, the terminal CPU 191 starts executing a process from a step 1700 of the routine shown in FIG. 17 and proceeds with the process to a step 1710 to determine whether an application starting-up interaction or operation is carried out. In other words, the terminal CPU 191 determines whether the predetermined touch interaction of starting up the remote moving application is applied to the display 110.

When the terminal CPU 191 determines “Yes” at the step 1710, the terminal CPU 191 proceeds with the process to a step 1720 to start up the remote moving application and display the initial display image G10. Next, the terminal CPU 191 proceeds with the process to a step 1730 to transmit the application started-up signal S10 to the outside. Next, the terminal CPU 191 proceeds with the process to a step 1795 to terminate executing this routine once.

On the other hand, when the terminal CPU 191 determines “No” at the step 1710, the terminal CPU 191 proceeds with the process to a step 1740 to determine whether an application terminating interaction or operation is carried out. In other words, the terminal CPU 191 determines whether the tapping interaction is applied to the application terminating image portion P15 or the like.

When the terminal CPU 191 determines “Yes” at the step 1740, the terminal CPU 191 proceeds with the process to a step 1750 to terminate executing the remote moving application. Next, the terminal CPU 191 proceeds with the process to a step 1760 to transmit the control terminating commanding signal S30 to the outside. Next, the terminal CPU 191 proceeds with the process to the step 1795 to terminate executing this routine once.

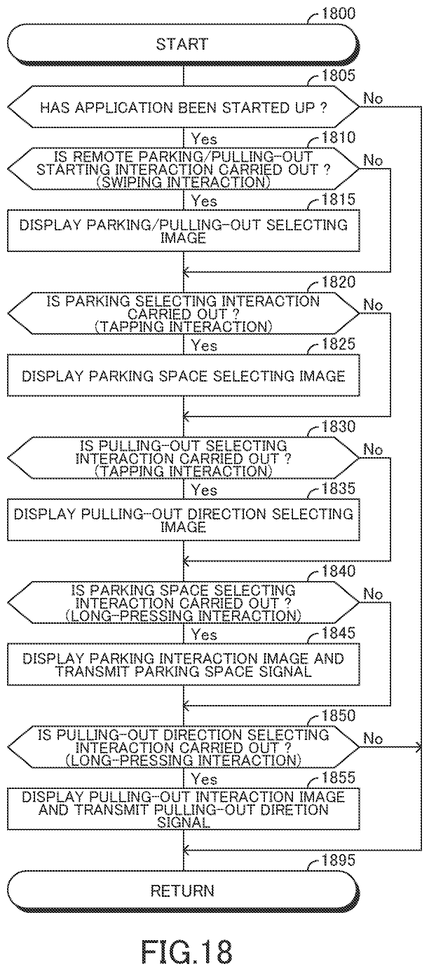

Further, the terminal CPU 191 is configured or programmed to execute a routine shown in FIG. 18 each time the predetermined calculation time elapses. Therefore, at a predetermined timing, the terminal CPU 191 starts executing a process from a step 1800 of the routine shown in FIG. 18 and proceeds with the process to a step 1805 to determine whether the remote moving application has been started up.

When the terminal CPU 191 determines “Yes” at the step 1805, the terminal CPU 191 proceeds with the process to a step 1810 to determine whether a remote parking/pulling-out starting interaction or operation is carried out. In other words, the terminal CPU 191 determines whether the swiping interaction is applied to the remote parking/pulling-out starting image portion P11.

When the terminal CPU 191 determines “Yes” at the step 1810, the terminal CPU 191 proceeds with the process to a step 1815 to display the parking/pulling-out selecting image G20 on the display 110. Next, the terminal CPU 191 proceeds with the process to a step 1820. On the other hand, when the terminal CPU 191 determines “No” at the step 1810, the terminal CPU 191 proceeds with the process directly to the step 1820.

When the terminal CPU 191 proceeds with the process to the step 1820, the terminal CPU 191 determines whether a parking selecting interaction or operation is carried out. In other words, the terminal CPU 191 determines whether the tapping interaction is applied to the parking selecting image portion P21.

When the terminal CPU 191 determines “Yes” at the step 1820, the terminal CPU 191 proceeds with the process to a step 1825 to display the parking space selecting image G30 on the display 110. Next, the terminal CPU 191 proceeds with the process to a step 1830. On the other hand, when the terminal CPU 191 determines “No” at the step 1820, the terminal CPU 191 proceeds with the process directly to the step 1830.

When the terminal CPU 191 proceeds with the process to the step 1830, the terminal CPU 191 determines whether a pulling-out selecting interaction or operation is carried out. In other words, the terminal CPU 191 determines whether the tapping interaction is applied to the pulling-out selecting image portion P22.

When the terminal CPU 191 determines “No” at the step 1830, the terminal CPU 191 proceeds with the process to a step 1835 to display the pulling-out direction selecting image G50 on the display 110. Next, the terminal CPU 191 proceeds with the process to a step 1840. On the other hand, when the terminal CPU 191 determines “No” at the step 1830, the terminal CPU 191 proceeds with the process directly to the step 1840.

When the terminal CPU 191 proceeds with the process to the step 1840, the terminal CPU 191 determines whether a parking space selecting interaction or operation is carried out. In other words, the terminal CPU 191 determines whether the long-pressing interaction is applied to the candidate parking space image portion P31.

When the terminal CPU 191 determines “Yes” at the step 1840, the terminal CPU 191 proceeds with the process to a step 1845 to display the parking interacting image G40 and transmit the parking space signal S12 to the outside. In this case, the terminal CPU 191 displays (i) the vehicle image G42 at the portion of the display 110 which corresponds to the position of the vehicle 200 which the vehicle position signal S13 represents, (ii) the parking remaining distance image G43 which displays the parking remaining distance Din which the parking remaining distance signal S15 represents on the display 110, and (iii) the moving direction image G47 which displays the moving direction of the vehicle 200 which the moving direction signal S17 represents on the display 110. Next, the terminal CPU 191 proceeds with the process to a step 1850. On the other hand, when the terminal CPU 191 determines “No” at the step 1840, the terminal CPU 191 proceeds with the process directly to the step 1850.

When the terminal CPU 191 proceeds with the process to the step 1850, the terminal CPU 191 determines whether a pulling-out direction selecting interaction or operation is carried out. In other words, the terminal CPU 191 determines whether the long-pressing interaction is applied to the candidate pulling-out direction image portion P53.

When the terminal CPU 191 determines “Yes” at the step 1850, the terminal CPU 191 proceeds with the process to a step 1855 to display the pulling-out interacting image G60 on the display 110 and transmit the pulling-out direction signal S22 to the outside. In this case, the terminal CPU 191 displays (i) the vehicle image G62 at the portion of the display 110 which corresponds to the position of the vehicle 200 which the vehicle position signal S23 represents and (ii) the pulling-out remaining distance image G63 which displays the pulling-out remaining distance Dout which the pulling-out remaining distance signal S25 represents on the display 110. Next, the terminal CPU 191 proceeds with the process to a step 1895 to terminate executing this routine once. On the other hand, when the terminal CPU 191 determines “No” at the step 1850, the terminal CPU 191 proceeds with the process directly to the step 1895 to terminate executing this routine once.

When the terminal CPU 191 determines “No” at the step 1805, the terminal CPU 191 proceeds with the process directly to the step 1895 to terminate executing this routine once.

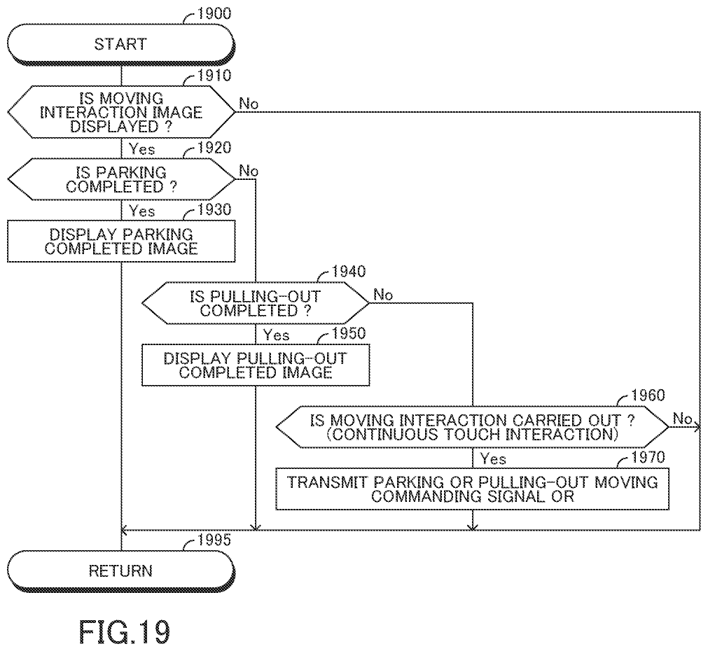

Further, the terminal CPU 191 is configured or programmed to execute a routine shown in FIG. 19 each time the predetermined calculation time elapses. Therefore, at a predetermined timing, the terminal CPU 191 starts a process from a step 1900 of the routine shown in FIG. 19 and proceeds with the process to a step 1910 to determine whether the parking moving interacting image G44 or the pulling-out moving interacting image G64 is displayed.

When the terminal CPU 191 determines “Yes” at the step 1910, the terminal CPU 191 proceeds with the process to a step 1920 to determine whether the vehicle 200 has been parked. In other words, the terminal CPU 191 determines whether the terminal CPU 191 receives the parking completed signal S18.

When the terminal CPU 191 determines “Yes” at the step 1920, the terminal CPU 191 proceeds with the process to a step 1930 to display the parking completed image G49 on the display 110. Next, the terminal CPU 191 proceeds with the process to a step 1995 to terminate executing this routine once.

On the other hand, when the terminal CPU 191 determines “No” at the step 1920, the terminal CPU 191 proceeds with the process to a step 1940 to determine whether the vehicle 200 has been pulled out. In other words, the terminal CPU 191 determines whether the terminal CPU 191 receives the pulling-out completed signal S28.

When the terminal CPU 191 determines “Yes” at the step 1940, the terminal CPU 191 proceeds with the process to a step 1950 to display the pulling-out completed image G69 on the display 110. Next, the terminal CPU 191 proceeds with the process to the step 1995 to terminate executing this routine once.

On the other hand, when the terminal CPU 191 determines “No” at the step 1940, the terminal CPU 191 proceeds with the process to a step 1960 to determine whether a moving interaction is carried out. In other words, the terminal CPU 191 determines whether the continuous touch interaction is applied to the parking moving interacting image portion P44 or the pulling-out moving interacting image portion P64.

When the terminal CPU 191 determines “Yes” at the step 1960, the terminal CPU 191 proceeds with the process to a step 1970 to transmit a moving commanding signal to the outside. In this case, the terminal CPU 191 transmits the parking moving commanding signal S16 as the moving commanding signal to the outside when the terminal CPU 191 is parking the vehicle 200 in the parking space. On the other hand, the terminal CPU 191 transmit the pulling-out moving commanding signal S26 as the moving commanding signal to the outside when the terminal CPU 191 is pulling out the vehicle 200 from the parking space. Next, the terminal CPU 191 proceeds with the process to the step 1995 to terminate executing this routine once. On the other hand, when the terminal CPU 191 determines “No” at the step 1960, the terminal CPU 191 proceeds with the process directly to the step 1995 to terminate executing this routine once.

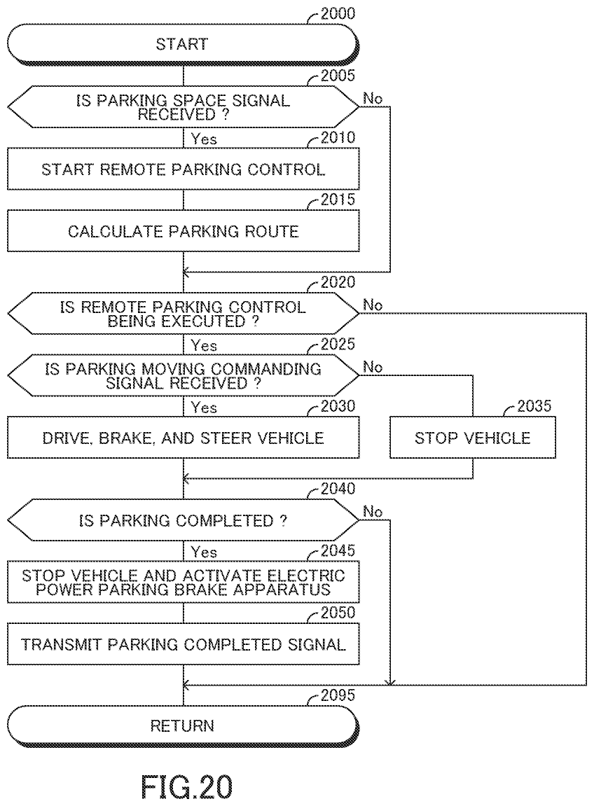

The vehicle CPU 291 of the remote moving system 10 is configured or programmed to execute a routine shown in FIG. 20 each time a predetermined calculation time elapses. Therefore, at a predetermined timing, the vehicle CPU 291 starts a process from a step 2000 of the routine shown in FIG. 20 and proceeds with the process to a step 2005 to determine whether the vehicle CPU 291 receives the parking space signal S14.

When the vehicle CPU 291 determines “Yes” at the step 2005, the vehicle CPU 291 proceeds with the process to a step 2010 to start executing the remote parking control. Next, the vehicle CPU 291 proceeds with the process to a step 2015 to calculate the parking route. Next, the vehicle CPU 291 proceeds with the process to a step 2020. On the other hand, when the vehicle CPU 291 determines “No” at the step 2005, the vehicle CPU 291 proceeds with the process directly to the step 2020.

When the vehicle CPU 291 proceeds with the process to the step 2020, the vehicle CPU 291 determines whether the remote parking control is being executed.

When the vehicle CPU 291 determines “Yes” at the step 2020, the vehicle CPU 291 proceeds with the process to a step 2025 to determine whether the vehicle CPU 291 receives the parking moving commanding signal S16.

When the vehicle CPU 291 determines “Yes” at the step 2025, the vehicle CPU 291 proceeds with the process to a step 2030 to drive or brake or steer the vehicle 200 so as to move the vehicle 200 along the parking route. Next, the vehicle CPU 291 proceeds with the process to a step 2040. On the other hand, when the vehicle CPU 291 determines “No” at the step 2025, the vehicle CPU 291 proceeds with the process to a step 2035 to brake and stop the vehicle 200. Next, the vehicle CPU 291 proceeds with the process to the step 2040.

When the vehicle CPU 291 proceeds with the process to the step 2040, the vehicle CPU 291 determines whether the vehicle 200 has been parked. In other words, the vehicle CPU 291 determines whether the vehicle 200 has reached the target parking space Pin_tgt by the remote parking control.

When the vehicle CPU 291 determines “Yes” at the step 2040, the vehicle CPU 291 proceeds with the process to a step 2045 to brake and stop the vehicle 200 and activate the electric power parking brake apparatus 220 to lock the wheels of the vehicle 200. Next, the vehicle CPU 291 proceeds with the process to a step 2050 to transmit the parking completed signal S18 to the outside. Next, the vehicle CPU 291 proceeds with the process to a step 2095 to terminate executing this routine once. On the other hand, when the vehicle CPU 291 determines “No” at the step 2040, the vehicle CPU 291 proceeds with the process directly to the step 2095 to terminate executing this routine once.

When the vehicle CPU 291 determines “No” at the step 2020, the vehicle CPU 291 proceeds with the process directly to the step 2095 to terminate executing this routine once.

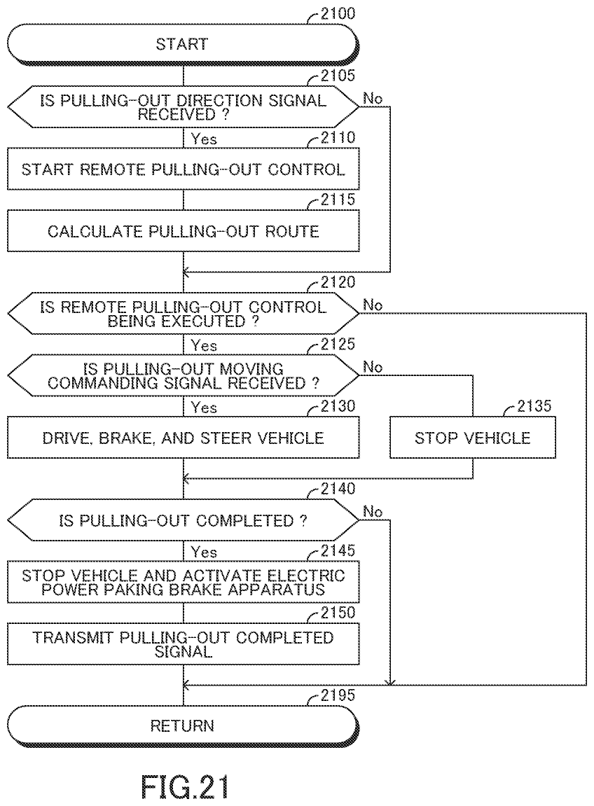

Further, the vehicle CPU 291 is configured or programmed to execute a routine shown in FIG. 21 each time the predetermined calculation time elapses. Therefore, at a predetermined timing, the vehicle CPU 291 starts a process from a step 2100 of the routine shown FIG. 21 and proceeds with the process to a step 2105 to determine whether the vehicle CPU 291 receives the pulling-out direction signal S22.

When the vehicle CPU 291 determines “Yes” at the step 2105, the vehicle CPU 291 proceeds with the process to a step 2110 to start the remote pulling-out control. Next, the vehicle CPU 291 proceeds with the process to a step 2115 to calculate the pulling-out route. Next, the vehicle CPU 291 proceeds with the process to a step 2120. On the other hand, when the vehicle CPU 291 determines “No” at the step 2105, the vehicle CPU 291 proceeds with the process directly to the step 2120.

When the vehicle CPU 291 proceeds with the process to the step 2120, the vehicle CPU 291 determines whether the remote pulling-out control is being executed.

When the vehicle CPU 291 determines “Yes” at the step 2120, the vehicle CPU 291 proceeds with the process to a step 2125 to determine whether the vehicle CPU 291 receives the pulling-out moving commanding signal S26.

When the vehicle CPU 291 determines “Yes” at the step 2125, the vehicle CPU 291 proceeds with the process to a step 2130 to drive or brake or steer the vehicle 200 so as to move the vehicle 200 along the pulling-out route. Next, the vehicle CPU 291 proceeds with the process to a step 2140. On the other hand, when the vehicle CPU 291 determines “No” at the step 2125, the vehicle CPU 291 proceeds with the process to a step 2135 to brake and stop the vehicle 200. Next, the vehicle CPU 291 proceeds with the process to the step 2140.

When the vehicle CPU 291 proceeds with the process to the step 2140, the vehicle CPU 291 determines whether the vehicle 200 has been pulled out. In other words, the vehicle CPU 291 determines the vehicle 200 has reached the target pulling-out point Pout_tgt by the remote pulling-out control.

When the vehicle CPU 291 determines “Yes” at the step 2140, the vehicle CPU 291 proceeds with the process to a step 2145 to brake and stop the vehicle 200 and activate the electric power parking brake apparatus 220 to lock the wheels of the vehicle 200. Next, the vehicle CPU 291 proceeds with the process to a step 2195 to terminate executing this routine once. On the other hand, when the vehicle CPU 291 determines “No” at the step 2140, the vehicle CPU 291 proceeds with the process directly to the step 2195 to terminate executing this routine once.

When the vehicle CPU 291 determines “No” at the step 2120, the vehicle CPU 291 proceeds with the process directly to the step 2195 to terminate executing this routine once.

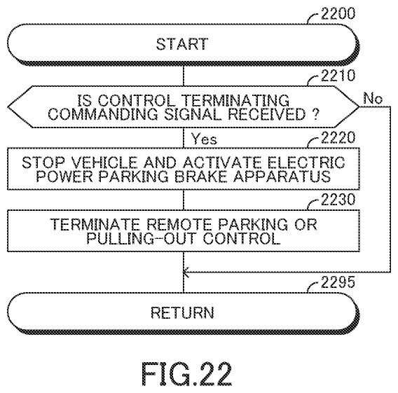

Further, the vehicle CPU 291 is configured or programmed to execute a routine shown in FIG. 22 each time the predetermined calculation time elapses. Therefore, at a predetermined timing, the vehicle CPU 291 starts executing a process from a step 2200 of the routine shown in FIG. 22 and proceeds with the process to a step 2210 to determine whether the vehicle CPU 291 receives the control terminating commanding signal S30.

When the vehicle CPU 291 determines “Yes” at the step 2210, the vehicle CPU 291 proceeds with the process to a step 2220 to brake and stop the vehicle 200 and activate the electric power parking brake apparatus 220 to lock the wheels of the vehicle 200. Next, the vehicle CPU 291 proceeds with the process to a step 2230 to terminate executing the remote parking/pulling-out control. In this case, when the vehicle CPU 291 executes the remote parking control, the vehicle CPU 291 terminates executing the remote parking control. On the other hand, when the vehicle CPU 291 executes the remote pulling-out control, the vehicle CPU 291 terminates executing the remote pulling-out control. Next, the vehicle CPU 291 proceeds with the process to a step 2295 to terminate executing this routine once.

On the other hand, when the vehicle CPU 291 determines “No” at the step 2210, the vehicle CPU 291 proceeds with the process directly to the step 2295 to terminate executing this routine once.

The specific operations of the remote moving system 10 has been described.

It should be noted that the invention is not limited to the embodiment. The invention can be modified without departing from a scope of the invention.

1. A remote moving system for remotely moving a vehicle with an operation terminal outside of the vehicle, wherein
the vehicle includes a vehicle moving apparatus which drives, brakes, and steers the vehicle and a vehicle electronic control unit which controls activations of the vehicle moving apparatus,
the operation terminal is configured to wirelessly communicate with the vehicle electronic control unit, and
the vehicle electronic control unit is configured to execute a remote moving control of (i) receiving a signal which is wirelessly transmitted from the operation terminal and (ii) moving the vehicle along a predetermined route by controlling the activations of the vehicle moving apparatus in accordance with the received signal,
wherein the operation terminal is configured to:
change its state from a first state to a second state when (i) the operation terminal is in the first state, and (ii) a predetermined first interaction is applied to the operation terminal; and
transmit a signal of commanding to move the vehicle to the vehicle electronic control unit when (i) the operation terminal is in the second state, and (ii) a predetermined second interaction different from the predetermined first interaction is applied to the operation terminal.

2. The remote moving system as set forth in claim 1, wherein the remote moving control is one of (i) a remote parking control of parking the vehicle in a parking space and (ii) a remote pulling-out control of pulling out the vehicle from the parking space.

3. The remote moving system as set forth in claim 1, wherein:
the operation terminal includes a display;
the predetermined first interaction and the predetermined second interaction are touch interaction to the display, respectively;
the touch interaction as the predetermined first interaction is one of (i) a swiping interaction, (ii) a sliding interaction, (iii) a long-pressing interaction, (iv) a tapping interaction, (v) an interaction of drawing a predetermined line, (vi) an interaction of inputting numbers, and (vii) a continuous touch interaction; and
the touch interaction as the predetermined second interaction is different from the touch interaction as the predetermined first interaction and is one of (i) the swiping interaction, (ii) the sliding interaction, (iii) the long-pressing interaction, (iv) the tapping interaction, (v) the interaction of drawing the predetermined line, (vi) the interaction of inputting the numbers, and (vii) the continuous touch interaction.

4. The remote moving system as set forth in claim 1, wherein:
the operation terminal is configured to change its state to the first state when plural kinds of interactions are applied to the operation terminal after the operation terminal starts up an application software of causing the vehicle electronic control unit to execute the remote moving control; and
the plural kinds of the interactions are different from each other and are different from the predetermined first interaction.
